(19) United States
(12) Patent Application Publication
(10) Pub. No.: US 2024/0062672 A1
(43) Pub. Date: Feb. 22, 2024

(54) RE-WRITABLE BOARD FOR MUSICAL INSTRUMENT INSTRUCTION

(71) Applicant: Lois Hope LINTON, West Chester, PA (US)

(72) Inventor: Lois Hope LINTON, West Chester, PA (US)

(21) Appl. No.: 18/234,025

(22) Filed: Aug. 15, 2023

Related U.S. Application Data
(60) Provisional application No. 63/399,376, filed on Aug. 19, 2022.

(51) Int. Cl. G09B 15/00; G10G 1/02; G09B 15/02; B43L 1/00

(52) U.S. Cl. CPC G09B 15/004; G10G 1/02; G09B 15/026; B43L 1/00

(57) ABSTRACT

A musical instrument instruction system includes a re-writable board having a writable surface suitable for use with erasable ink, and a first non-erasable image of at least a portion of a violin family instrument. The first non-erasable image is disposed within the writable surface of the re-writable board to enable overlap of the first non-erasable image by erasable ink received on the writable surface.

### CROSS-REFERENCE TO RELATED APPLICATIONS

This application claims the benefit of U.S. Provisional Patent Application No. 63/399,376, filed on Aug. 19, 2022, entitled “Re-Writable Board for Musical Instrument Instruction,” currently pending, the entire contents of which are incorporated by reference herein.

### BACKGROUND

Embodiments described herein relate generally to a musical instrument instruction system and its usage, and more particularly, to a re-writable board for instruction for instruments in the violin family that allows erasable indications of visual representation for finger placement or other operation of the particular violin family instrument.

Beginning and intermediate string players often struggle with recalling and differentiating between finger patterns, knowing how to shift to different positions, where to put their fingers in those positions, and adjusting fingers in the right direction for accurate intonation (lower or higher). Music teachers have been lacking an adequate teaching tool for instructing students on proper finger positioning, particularly for visual or kinesthetic learners in a mostly sonic space.

It is therefore desired to provide a reusable visual instruction tool that can allow a teacher to demonstrate proper finger positioning for playing a violin family instrument and allow a student to demonstrate mastery of finger positioning concepts, among other advantages. Applicant has found that the system described herein has aided music students for faster and improved learning and retention of finger positions in performance with their instruments.

### BRIEF SUMMARY

Briefly stated, one embodiment comprises a musical instrument instruction system including a re-writable board having a writable surface suitable for use with erasable ink, and a first non-erasable image of at least a portion of a violin family instrument. The first non-erasable image is disposed within the writable surface of the re-writable board to enable overlap of the first non-erasable image by erasable ink received on the writable surface.

In one aspect, the at least a portion of the violin family instrument is a fingerboard of the violin family instrument. In a further aspect, the violin family instrument is one of a violin, a viola, a cello, or a double bass. In a still further aspect, the fingerboard depicts one or more stripes indicating predetermined finger positions on the fingerboard.

In another aspect, a second non-erasable image of a blank music staff is disposed within the writable surface of the re-writable board to enable overlap of the second non-erasable image by erasable ink received on the writable surface.

In yet another aspect, the first non-erasable image is formed on a cardstock, and the writable surface of the re-writable board includes a clear laminate material overlying the cardstock.

Another embodiment comprises a musical instrument instruction booklet including a plurality of pages each depicting a permanent image of at least a portion of a violin family instrument, a re-writable board bound to the plurality of pages and having a writable surface suitable for use with erasable ink, and a non-erasable image of at least a portion of the violin family instrument. The non-erasable image is disposed within the writable surface of the re-writable board to enable overlap of the non-erasable image by erasable ink received on the writable surface.

In one aspect, the at least a portion of the violin family instrument is a fingerboard of the violin family instrument. In a further aspect, the violin family instrument is one of a violin, a viola, a cello, or a double bass.

In another aspect, the non-erasable image is formed on a cardstock, and the writable surface of the re-writable board includes a clear laminate material overlying the cardstock.

### BRIEF DESCRIPTION OF THE SEVERAL VIEWS OF THE DRAWINGS

The following detailed description of preferred embodiments will be better understood when read in conjunction with the appended drawings. For the purpose of illustration, there are shown in the drawings embodiments which are presently preferred. It should be understood, however, that the invention is not limited to the precise arrangements and instrumentalities shown.

In the drawings:

FIG. 1 is a front elevational view of a musical instrument instruction system in accordance with an example embodiment of the present invention;

FIG. 2 is a front elevational view of the system of FIG. 1 with a finger pattern scale drawn thereon with erasable ink;

FIG. 3 is a front elevational view of the system of FIG. 1 with a finger pattern scale and shift drawn thereon with erasable ink;

FIG. 4 is a front elevational view of the system of FIG. 1 with two different finger placements drawn thereon with erasable ink;

FIG. 5 is a front elevational view of the system of FIG. 1 with a vibrato spacing finger pattern drawn thereon with erasable ink;

FIG. 6 is a front elevational view of the system of FIG. 1 with a chord pattern drawn thereon with erasable ink; and

FIG. 7 is a right side perspective view of a booklet incorporating the system of FIG. 1.

### DETAILED DESCRIPTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

It should also be understood that the terms “about,” “approximately,” “generally,” “substantially” and like terms, used herein when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

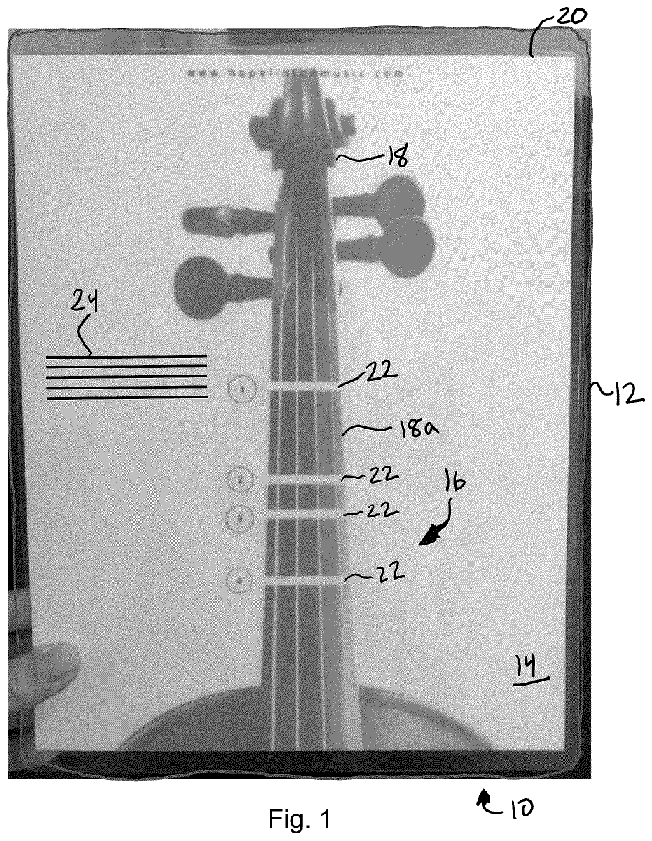

Referring to FIG. 1, there is shown an example of a musical instrument instruction system 10. The musical instrument instruction system 10 may include a re-writable board 12 having a writable surface 14 suitable for use with erasable ink. The writable surface 14 may constitute an entire front surface of the re-writable board 12, as shown in FIG. 1. However, in some embodiments, the re-writable board 12 may include a nonwritable frame, border, or the like (not shown) surrounding or adjacent at least a portion of the writable surface 14.

The writable surface 14 may be, for example, a dry-erase board or similar surface made from nonporous material to prevent or minimize absorption of appropriate inks and enable erasure of marks made with such inks. The material of the writable surface 14 may be a hardcoat laminate material, glass, a polymeric film, melamine resin, or the like. Portions of the writable surface 14 and/or other segments of the re-writable board 12 may also be magnetic, may allow for temporary adhesion (e.g., a sticky-note board or the like), combinations thereof, or the like. Erasable ink usable with the writable surface 14 may be provided in a conventional dry-erase marker (not shown) or similar ink, which may contain a silicone polymer with alcoholic solvent, or the like. It is also contemplated that the writable surface 14 may be compatible with wet-erase markers or similar inks utilizing a water-based paste or the like.

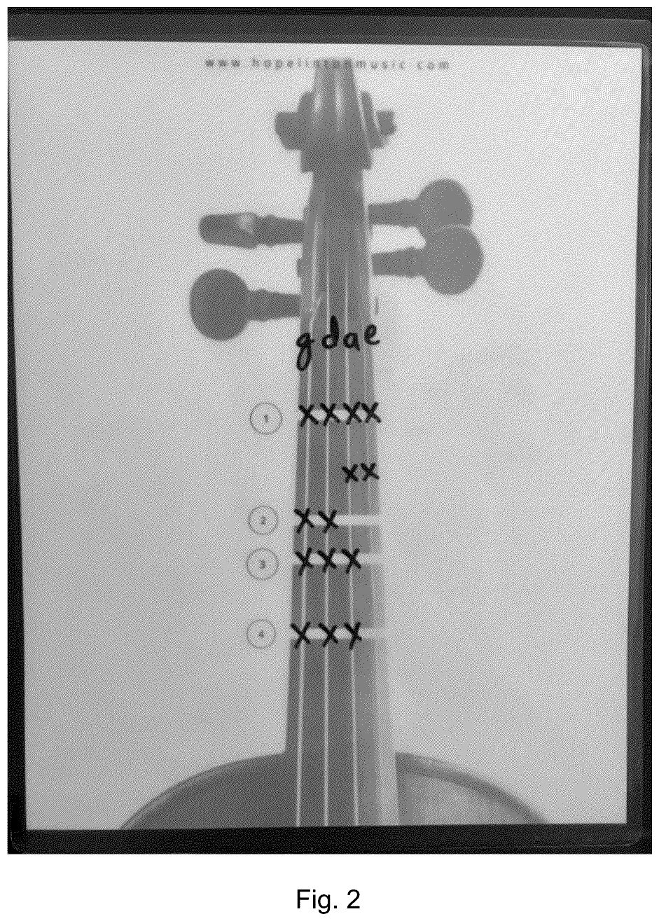

The musical instrument instruction system 10 further includes at least a first non-erasable image 16 of at least a portion of a violin family instrument 18. The first non-erasable image 16 may be disposed within the writable surface 14 to enable overlap of the first non-erasable image 16 by erasable ink received on the writable surface 14. This enables a user of the musical instrument instruction system 10 to reversibly mark the portion of the violin family instrument 18 with erasable ink, such as shown in FIGS. 2-6, for example.

In the example shown in FIG. 1, the first non-erasable image 16 is printed on a cardstock 20 that is overlaid by a clear hardcoat laminate material forming the writable surface 14 of the re-writable board 12. However, other methods for providing the first non-erasable image 16 may be used as well, such as direct printing, deposition, or adhering of the first non-erasable image 16 onto the writable surface 14, overcoating or overlaying the first non-erasable image 16 with a clear nonporous material, or the like.

The portion of the violin family instrument 18 shown in the first non-erasable image 16 may be, for example, a fingerboard thereof. In the example shown in FIG. 1, the first non-erasable image 16 shows a fingerboard 18a of a violin 18. However, other stringed instruments in the family, including a viola, cello, or double bass, may be depicted. The first non-erasable image 16 further depicts a plurality of stripes 22, which is similar to the placement of tape or stickers on a fingerboard 18a to indicate predetermined finger positions on the fingerboard 18a (e.g., correlating to particular commonly used notes). The optional use of one or more of these stripes 22 in the first non-erasable image 16 makes finger patterns placed by a user with erasable ink over the violin family instrument 18 easier to comprehend given that the one or more stripes 22 provide simple reference landmarks that can be translated to placement on the actual instrument. Although stripes 22 are depicted in FIG. 1, other types of reference markings, such as round stickers, notches, and/or other like visual aids may be utilized in the first non-erasable image 16 as well. While shown in FIG. 1 as mainly the fingerboard 18a of the violin family instrument 18, the first non-erasable image 16 may depict any portion, or the entirety, of the violin family instrument 18 as needed for instruction.

It may be beneficial to also have additional non-erasable images 24 disposed within the writable surface 14 for overlap by erasable ink markings made by a user of the musical instrument instruction system 10. FIG. 1 shows one example, which is a blank music staff 24, which can be used, e.g., to correlate notes to markings on the fingerboard 18a. Other types of non-erasable images 24 that may be utilized in the writable surface 14 can include, for example, a diagram of note names, placements, and/or positions, a section to write notes or reminders, a small rhythm key, a space for a key signature or circle of fifths, a sketch or diagram of additional components of the violin family instrument 18 (e.g., a bow), or the like.

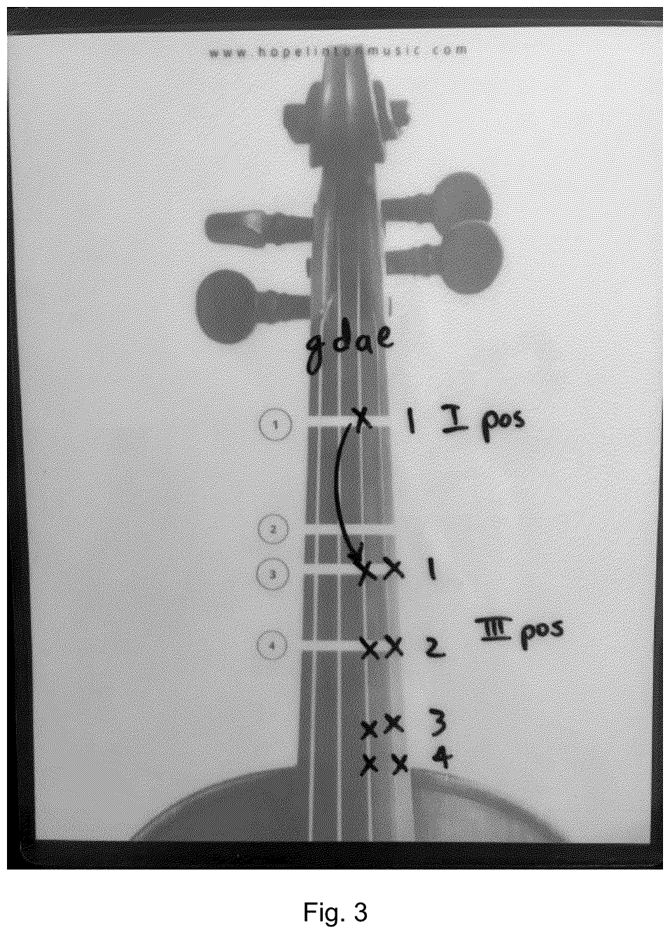

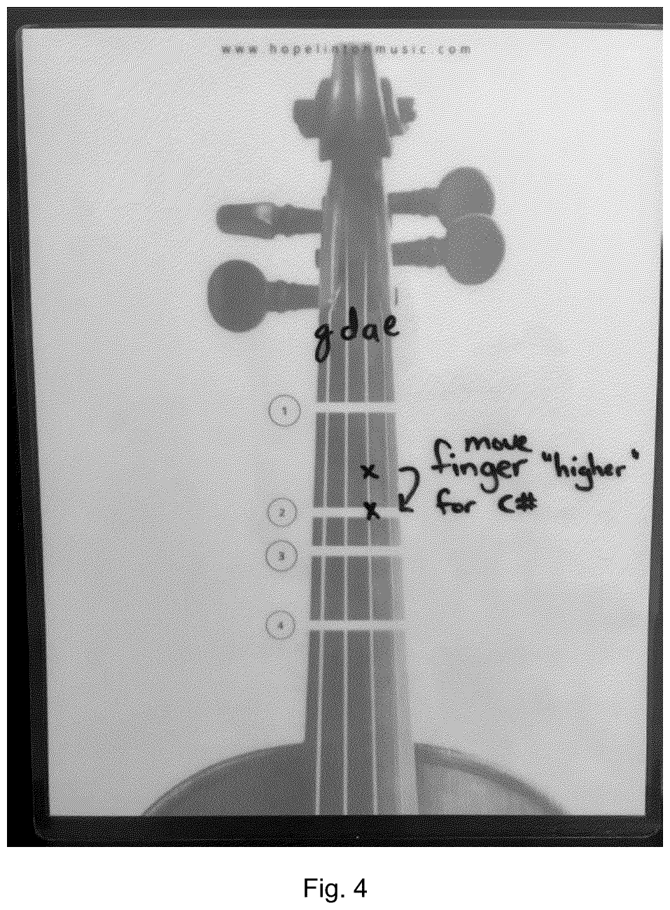

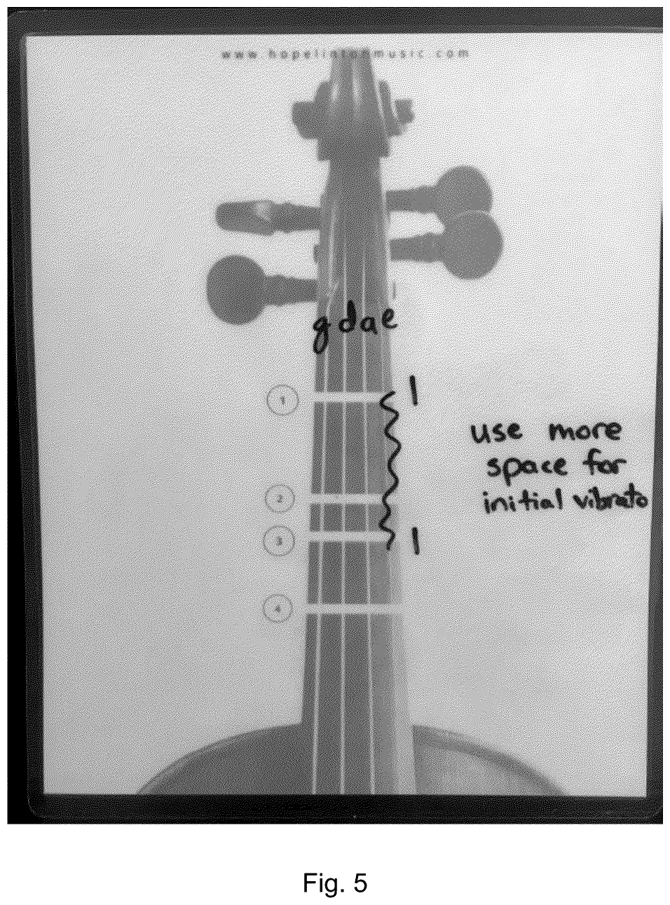

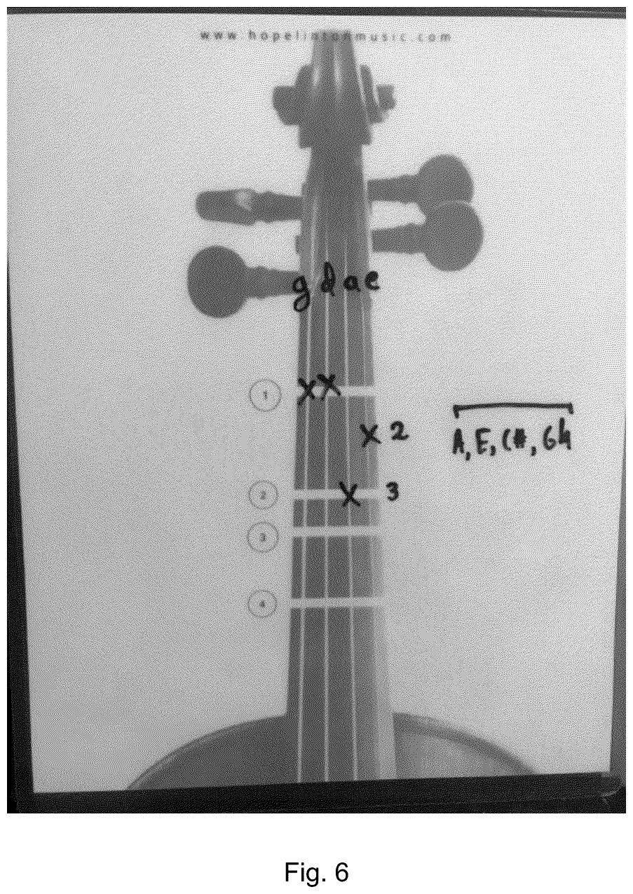

FIGS. 2-6 show various uses of the musical instrument instruction system 10 of FIG. 1 by placement of erasable ink over the first non-erasable image of the violin family instrument 18. For example, FIG. 2 shows a drawing of a G-major finger pattern in the first position (two octaves) on the fingerboard 18a of the violin 18. FIG. 3 shows a drawing of a demonstration on how to shift fingers between first and third positions in the second octave for a D-major finger pattern on the fingerboard 18a of the violin 18. FIG. 4 shows a drawing of a finger placement for intonation adjustment on the fingerboard 18a of the violin 18. FIG. 5 shows a drawing of the amount of space to use when executing vibrato on the fingerboard 18a of the violin 18. FIG. 6 shows a drawing of finger spacing for a chord on the fingerboard 18a of the violin 18.

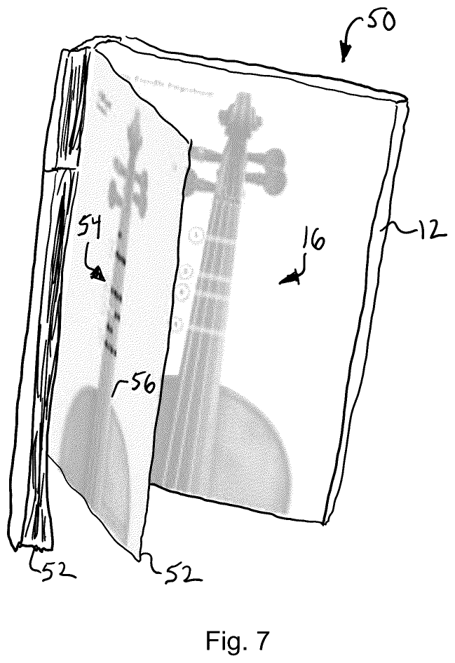

The musical instrument instruction system 10 as described above may further be appended or included as part of a musical instruction booklet 50, such as the booklet shown in FIG. 7. The booklet 50 may include a plurality of pages 52, each depicting a permanent image 54 of at least a portion of a violin family instrument 56. As an example, the plurality of pages 52 may provide finger pattern charts such as for major and minor keys, various skills, or the like. In some instances, the permanent image 54 on these pages 52 may be identical to the first non-erasable image 16 on the rewritable board 12. However, in some instances, there may be some differences between the permanent image 54 and the non-erasable image 16. Of course, other pages (not shown) may also be included in the booklet 50 that do not have the permanent image 54, and instead have explanatory text, scratch paper, blank music staffs, or the like. The rewritable board 12 may be bound the plurality of pages 52 using, for example, spiral coils, loose-leaf rings, threading, spine combs, or the like.

While specific and distinct embodiments have been shown in the drawings, various individual elements or combinations of elements from the different embodiments may be combined with one another while in keeping with the spirit and scope of the invention. Thus, an individual feature described herein only with respect to one embodiment should not be construed as being incompatible with other embodiments described herein or otherwise encompassed by the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A musical instrument instruction system comprising:
a re-writable board having a writable surface suitable for use with erasable ink; and
a first non-erasable image of at least a portion of a violin family instrument, the first non-erasable image being disposed within the writable surface of the re-writable board to enable overlap of the first non-erasable image by erasable ink received on the writable surface.

2. The musical instrument instruction system of claim 1, wherein the at least a portion of the violin family instrument is a fingerboard of the violin family instrument.

3. The musical instrument instruction system of claim 2, wherein the violin family instrument is one of a violin, a viola, a cello, or a double bass.

4. The musical instrument instruction system of claim 2, wherein the fingerboard depicts one or more stripes indicating predetermined finger positions on the fingerboard.

5. The musical instrument instruction system of claim 1, further comprising a second non-erasable image of a blank music staff disposed within the writable surface of the re-writable board to enable overlap of the second non-erasable image by erasable ink received on the writable surface.

6. The musical instrument instruction system of claim 1, wherein the first non-erasable image is formed on a cardstock, and the writable surface of the re-writable board includes a clear laminate material overlying the cardstock.

7. A musical instrument instruction booklet comprising:
a plurality of pages each depicting a permanent image of at least a portion of a violin family instrument;
a re-writable board bound to the plurality of pages and having a writable surface suitable for use with erasable ink; and
a non-erasable image of at least a portion of the violin family instrument, the non-erasable image being disposed within the writable surface of the re-writable board to enable overlap of the non-erasable image by erasable ink received on the writable surface.

8. The booklet of claim 7, wherein the at least a portion of the violin family instrument is a fingerboard of the violin family instrument.

9. The booklet of claim 8, wherein the violin family instrument is one of a violin, a viola, a cello, or a double bass.

10. The booklet of claim 7, wherein the non-erasable image is formed on a cardstock, and the writable surface of the re-writable board includes a clear laminate material overlying the cardstock.
